(19) United States
(12) Patent Application Publication
(10) Pub. No.: US 2025/0320090 A1
(43) Pub. Date: Oct. 16, 2025

(54) LOAD POSITIONING SYSTEM, PARTIALLY-ASSEMBLED BRIDGE, AND PROCESS OF ASSEMBLING A BRIDGE

(71) Applicant: Advanced Construction Robotics, Inc., Allison Park, PA (US)

(72) Inventors: Joshua S. TELSON, Pittsburgh, PA (US); Patrick A Weber, Wexford, PA (US); Danielle A Proctor, Sewickley, PA (US); Stephen M Muck, Butler, PA (US); Geoffrey K White, Valencia, PA (US)

(21) Appl. No.: 18/636,403

(22) Filed: Apr. 16, 2024

(51) Int. Cl. B66C 17/06; E01D 21/00

(52) U.S. Cl. CPC B66C 17/06; E01D 21/00

(57) ABSTRACT

The present disclosure is directed to a load positioning system, a partially-assembled bridge, and a process of assembling a bridge. The load positioning system includes a gantry extending over a structure of a partially-assembled bridge, the partially-assembled bridge at least partially extending over a physical feature, a load descent mechanism arranged and disposed to lower a load having a mass of at least 10 kg onto the structure, and a load location mechanism arranged and disposed to move the load from being laterally-proximal to a first location of the structure and laterally-distal to a second location of the structure to being laterally-distal from the first location of the structure and laterally-proximal to the second location of the structure. The load descent mechanism and the load location mechanism are physically supported by the gantry. The process of assembling a bridge includes using the load descent mechanism.

### FIELD OF THE INVENTION

The present disclosure is directed to load positioning in the assembly of bridges. More particularly, the present disclosure is directed to a load positioning system, a partially-assembled bridge, and a process of assembling a bridge.

### BACKGROUND OF THE INVENTION

Construction involves heavy, precarious, and difficult to balance situations. However, having access to heavy, bulky, imbalanced, or otherwise difficult to handle loads can be important. Cranes are often used for such situations. Cranes can include a hook extending from an upper heave of a jib with a boom point connected to a lattice boom that connects to an operator's cab that serves as a counterweight. Such configurations suffer from drawbacks of being difficult to use in certain environments, expensive to move, and subject to substantial forces that can create hazardous situations.

Systems, structures, and processes that show one or more improvements in comparison to the prior art would be desirable in the art.

### BRIEF DESCRIPTION OF THE INVENTION

In an embodiment, a load positioning system includes a gantry extending over a structure of a partially-assembled bridge, the partially-assembled bridge at least partially extending over a physical feature, a load descent mechanism arranged and disposed to lower a load having a mass of at least 10 kg onto the structure, and a load location mechanism arranged and disposed to move the load from being laterally-proximal to a first location of the structure and laterally-distal to a second location of the structure to being laterally-distal from the first location of the structure and laterally-proximal to the second location of the structure. The load descent mechanism and the load location mechanism are physically supported by the gantry.

In another embodiment, a partially-assembled bridge includes a structure at least partially extending over a physical feature. The structure includes components for assembling a bridge, a load having a mass of at least 10 kg, a gantry, and a load positioning system having a load descent mechanism and a load location mechanism. The load descent mechanism is arranged and disposed to lower the load onto at least a portion of the structure and the load location mechanism is arranged and disposed to move the load from being laterally-proximal to a first location of the structure and laterally-distal to a second location of the structure to being laterally-distal from the first location of the structure and laterally-proximal to the second location of the structure. The load descent mechanism and the load location mechanism are physically supported by the gantry.

In another embodiment, a process of assembling a bridge includes providing a structure at least partially extending over a physical feature, the structure including components for assembling a bridge, providing a load positioning system having a load descent mechanism and a load location mechanism, using the load descent mechanism to lower a load having a mass of at least 10 kg onto at least a portion of the structure, and using the load location mechanism to move the load from being laterally-proximal to a first location of the structure and laterally-distal to a second location of the structure to being laterally-distal from the first location of the structure and laterally-proximal to the second location of the structure. The load descent mechanism and the load location mechanism are physically supported by a gantry.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows load positioning system, a partially-assembled bridge, and a process of assembling a bridge, according to embodiments of the disclosure.

FIG. 2 shows ratings for loads corresponding to embodiments of the load positioning system.

FIG. 3 shows distances between contact points on a screed rail to avoid damage to the screed rail, according to an embodiment of the disclosure.

FIG. 4 shows portions of an embodiment of the load descent mechanism, according to the disclosure.

FIG. 5 shows portions of an embodiment of the load descent mechanism, according to the disclosure.

FIG. 6 shows portions of an embodiment of the load descent mechanism, according to the disclosure.

FIG. 7 shows an embodiment of the load positioning system, according to the disclosure.

FIG. 8 shows another embodiment of the load positioning system, according to the disclosure.

FIG. 9 shows another embodiment of the load positioning system, according to the disclosure.

FIG. 10 shows an embodiment of the load positioning system, according to the disclosure.

FIG. 11 shows an embodiment of the load positioning system, according to the disclosure.

FIG. 12 shows an embodiment of the load positioning system, according to the disclosure.

FIG. 13 shows an embodiment of the load positioning system, according to the disclosure.

FIG. 14 shows an embodiment of the load positioning system, according to the disclosure.

FIG. 15 shows an embodiment of the load positioning system, according to the disclosure.

FIG. 16 shows an embodiment of the load positioning system, according to the disclosure.

Wherever possible, the same reference numbers will be used throughout the drawings to represent the same parts.

### DETAILED DESCRIPTION OF THE INVENTION

Provided are a load positioning system, a partially-assembled bridge, and a process of assembling a bridge, according to embodiments of the disclosure. Embodiments of the present disclosure, for example, in comparison to concepts failing to include one or more of the features disclosed herein, permit improvements over existing technology, for example, increase safety, reduce on-site injury, allow humans to be more efficient, allow heavier items to be used during bridge assembly, allow movement of a load without a boom (such as an extension on a crane positioned to extend above the horizontal), allow loads to be transported with multiple support points, allow enhanced stability of loads, provide cost savings, reduce the movement or demand for site support equipment, lower environmental impact, or combinations thereof.

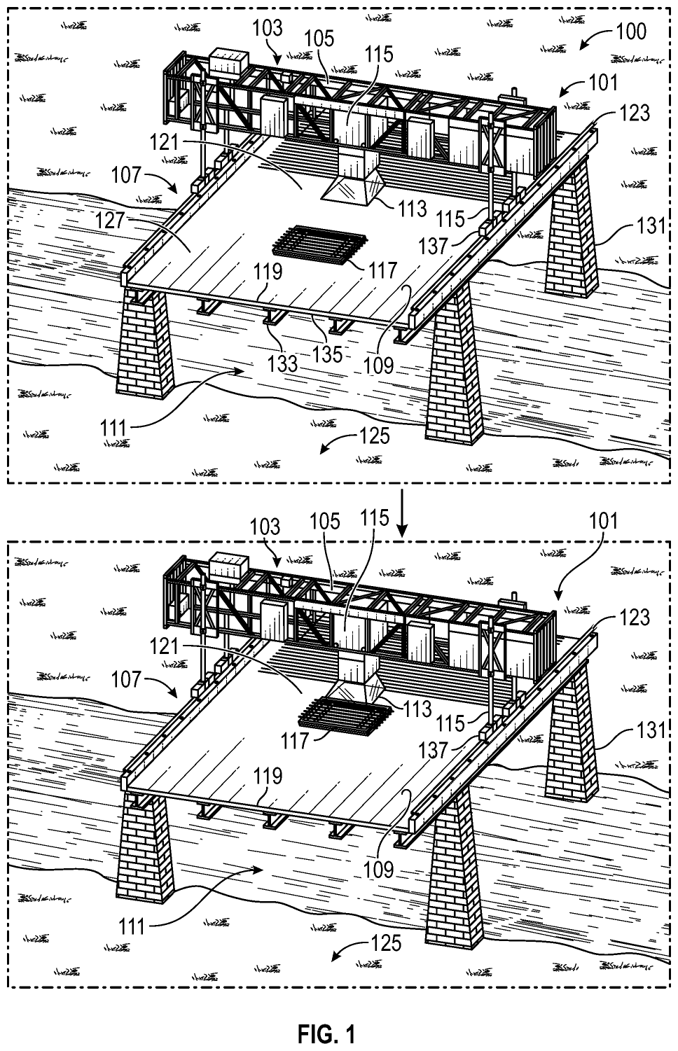

Referring to FIG. 1, according to an embodiment, a load positioning system 101 includes a support system 103, such as a gantry 105, extending over a structure 107 of, for example, a partially-assembled bridge 109. The partially-assembled bridge 109 at least partially (or entirely) extends over a physical feature 111. Examples of the physical feature 111 include a body of water (for example, a river, ocean, lake, bog, swamp, bay, inlet, canal, or a combination thereof), land 125 (for example, a beach, an island, a peninsula, a field, a mountain, a valley, or a combination thereof), unstable ground (for example, sand, peat, silt, a tidal zone, or a combination thereof), a paved or otherwise man-made surface (for example, a road, a pedestrian path, a bike path, a tunnel, an underpass, or a combination thereof), a utility path, a storm management system, a railway, an environmentally sensitive area, or a combination thereof.

In one embodiment, the support system 103 includes some or all of the features described in U.S. Pat. No. 10,061,323, entitled “Autonomous Apparatus and System for Repetitive Tasks in Construction Project” and/or U.S. Pat. No. 10,597,264, entitled “Semi-Autonomous System for Carrying and Placing Elongate Objects,” each of which are incorporated by reference in their entirety. The support system 103 of the present disclosure includes further features, such as a load descent mechanism 113 and a load location mechanism 115.

According to the present disclosure, the load positioning system 101 includes the load descent mechanism 113 and the load location mechanism 115. The load descent mechanism 113 and the load location mechanism 115 are at least partially or completely physically supported by the support system 103.

The load descent mechanism 113 is capable of having various components (and, in some embodiments, one, two, three, four, or more additional load descent mechanisms supported by the gantry 105).

The load descent mechanism 113 is arranged and disposed to lower a load 117 having a mass of at least 10 kg onto the structure 107. In further embodiments, the load descent mechanism 113 is rated for handling the mass being at least 50 kg, 100 kg, 225 kg to 230 kg (encompassing 500 pounds), 450 kg to 455 kg (encompassing 1,000 pounds), 905 kg to 910 kg (encompassing 2,000 pounds), 1,360 kg to 1,365 kg (encompassing 3,000 pounds), 1,810 kg to 1,815 kg (encompassing 4,000 pounds), or any suitable combination, sub-combination, range, or sub-range therein. In a further embodiment, the load descent mechanism 113 is able to lift, move, reposition, reorient, tilt, twist, rotate, or otherwise adjust the load 117. In an even further embodiment, the ability to move is limited based upon measurements of the mass of the load 117 to avoid damage to the load descent mechanism 113.

In one embodiment, the load location mechanism 115 is rated for handling the load 117 and is rated for handling the mass at the same level, a higher level, or a lower level than the load descent mechanism 113. For example, in embodiments where the load location mechanism 115 positions portions of the load 117, the load location mechanism 115 is capable of being rated at a lower level. Similarly, in embodiments where the load location mechanism 115 is transferring portions to the load descent mechanism 113, the load location mechanism 115 is capable of being rated at a higher level.

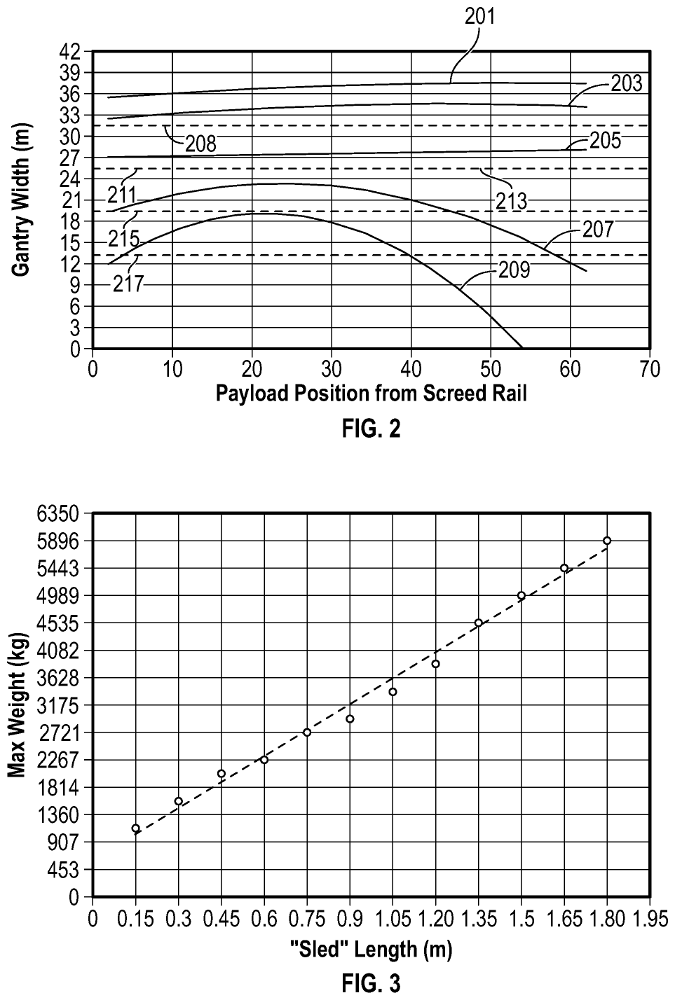

Referring to FIG. 2, in one embodiment, the rating for the mass for the load 117 able to be positioned by the load location mechanism 115 incorporates dimensions of the support system 103, for example, the width of the gantry 105 and the distance of the load 117 from the location providing support for the load, such as the distance from the screed rail 123 as mass-based load curves. A first mass-based load curve 201 corresponds with 225 kg to 230 kg (encompassing 500 pounds). A second mass-based load curve 203 corresponds with 450 kg to 455 kg (encompassing 1,000 pounds). A third mass-based load curve 205 corresponds with 905 kg to 910 kg (encompassing 2,000 pounds). A fourth mass-based load curve 207 corresponds with 1,360 kg to 1,365 kg (encompassing 3,000 pounds). A fifth mass-based load curve 209 corresponds with 1,810 kg to 1,815 kg (encompassing 4,000 pounds). As will be appreciated by those skilled in the art, the rating is based upon a factor of safety rating, which is a ratio of a maximum tolerable load divided by an actual working load. The curves are capable of being adjusted to address different ratios, for example, from being based upon a 1.5 ratio to being based upon a 1.3 ratio.

Additionally or alternatively, in one embodiment, a grade associated with the orientation of the support system 103 is plotted against the mass-based load curve(s) to validate conditions. For example, one validation 208 includes the grade being 0.6% with a cross slope being-5.6%, a second validation 211 includes the grade being 0.5% with a cross slope being 0%, a third validation 213 includes the grade being 5% with a cross slope being 0%, a fourth validation 215 includes the grade being-3.2% with a cross slope being 2%, and a fifth validation 217 includes the grade being 0.5% with a cross slope being 0%.

Suitable grade limits include up to 4%, up to 5%, up to 6%, between 1% and 6%, between 2% and 6%, between 3% and 6%, between 4% and 6% between 5% and 6%, between 1% and 5%, between 2% and 5%, between 3% and 5%, between 4% and 5%, between 1% and 4%, between 2% and 4%, between 3% and 4%, or any suitable combination, sub-combination, range, or sub-range therein. Additionally or alternatively, suitable cross slope limits include up to 4%, up to 5%, up to 6%, up to 7%, up to 8%, between 1% and 8%, between 2% and 8%, between 3% and 8%, between 4% and 8% between 5% and 8%, between 6% and 8%, between 7% and 8%, between 1% and 7%, between 2% and 7%, between 3% and 7%, between 4% and 7% between 5% and 7%, between 6% and 7%, between 1% and 6%, between 2% and 6%, between 3% and 6%, between 4% and 6% between 5% and 6%, between 1% and 5%, between 2% and 5%, between 3% and 5%, between 4% and 5%, between 1% and 4%, between 2% and 4%, between 3% and 4%, or any suitable combination, sub-combination, range, or sub-range therein.

Suitable widths for the support system 103 include up to 5 meters, up to 10 meters, up to 15 meters, up to 20 meters, up to 25 meters, up to 30 meters, up to 35 meters, up to 40 meters, up to 45 meters, between 5 meters and 45 meters, between 10 meters and 45 meters, between 15 meters and 45 meters, between 15 meters and 45 meters, between 20 meters and 45 meters, between 25 meters and 45 meters, between 30 meters and 45 meters, between 40 meters and 45 meters, between 5 meters and 35 meters, between 10 meters and 35 meters, between 15 meters and 35 meters, between 15 meters and 35 meters, between 20 meters and 35 meters, between 25 meters and 35 meters, between 5 meters and 25 meters, between 10 meters and 25 meters, between 15 meters and 25 meters, between 15 meters and 25 meters, between 20 meters and 25 meters, or any suitable combination, sub-combination, range, or sub-range therein.

The load 117 is anything suitable for positioning and lowering on the partially-assembled bridge 109 within the range of the mass appropriate for the support system 103. For example, the mass appropriate incorporates the load 117, other features supported by the support system 103 (such as robots), and the support system 103 itself. According to various embodiments, the load 117 is or includes components for the partially-assembled bridge 109 (for example, a deck pan, deck pan angle brackets, rebar, screed rail, screed rail supports, concrete, wood, beams, girders, shear connectors, bearing sets, overhang jacks, rebar supports, or combinations thereof), tools for the process 100 of constructing the bridge (for example, tools, jack-hammers, curing systems, heaters, fans, generators, batteries, heat exchangers, water filtration systems, water purifying systems, mixers, safety systems, storage containers, or combinations thereof), systems for analyzing the partially-assembled bridge 109 (for example, acoustic measurement systems, optical measurement systems, moisture measuring systems, or combinations thereof), or any suitable combination thereof.

The load 117 has any suitable dimensions capable of being positioned and lowered on the partially-assembled bridge 109 by the load positioning system 101. In one embodiment, with the load 117 being rebar, the dimensions include one or a bundle of rebar having dimensions of greater than 1 meter, greater than 2 meters, greater than 5 meters, greater than 10 meters, greater than 15 meters, greater than 20 meters, between 1 and 20 meters, between 5 and 20 meters, between 10 and 20 meters, between 15 and 20 meters, between 1 and 10 meters, between 2 and 10 meters, between 5 and 10 meters, or any suitable combination, sub-combination, range, or sub-range therein.

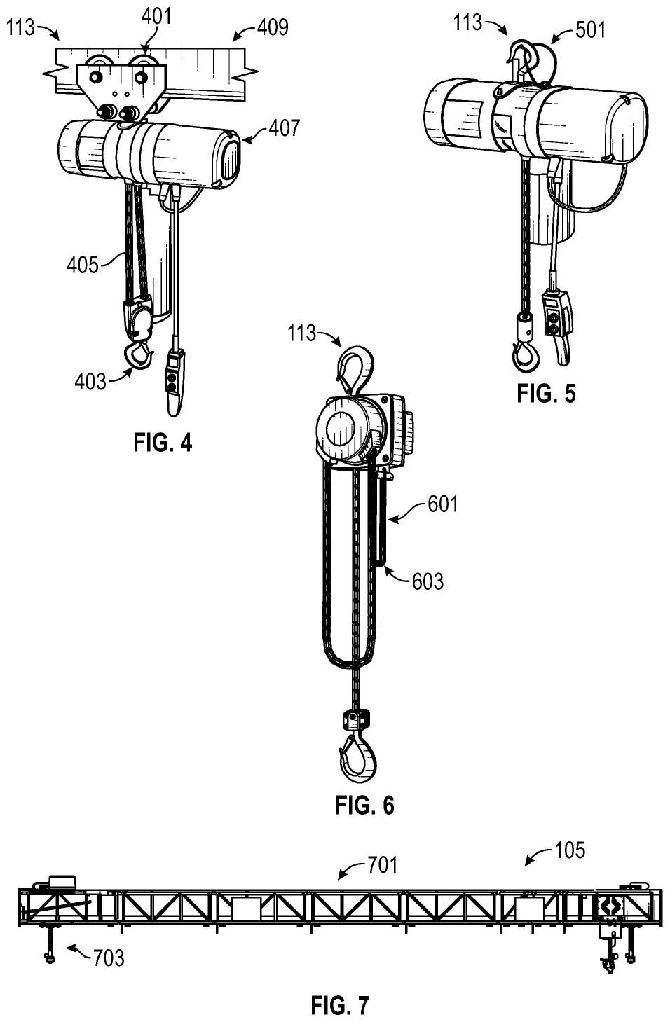

Referring to FIG. 4, in one embodiment, the load descent mechanism 113 is suspended from a trolley 401 and has a load-securing hook 403 on a chain 405 controlled by a power hoist 407. The trolley 401 is configured to travel along a track 409 allowing repositioning. The chain 405 extends or retracts through operation of the power hoist 407 to raise and lower the load 117.

Referring to FIG. 5, in one embodiment, the load descent mechanism 113 is suspended from a hook 501. The hook 501 is able to be connected to the gantry 105, for example, in a permanent or removeable manner. Movement of the hook 501 relative to the gantry 105 allows the weight of the load 117 to align the load descent mechanism 113 with the direction of gravity, thereby allowing for operation of the load descent mechanism 113 to be aligned relative to the direction of gravity.

Referring to FIG. 6, in one embodiment, the load descent mechanism 113 includes a pulley arrangement 601. The pulley arrangement 601 allows for the load 117 to be raised or carefully lowered from a distance away from the load, for example, by having a pulley chain 603 extending from the load positioned at an angle relative to the direction of gravity (suitable angles for the pulley chain 603 or other tethered controls in general include, from the direction of gravity, between 15 and 85 degrees, between 15 and 75 degrees, between 15 and 60 degrees, between 15 and 45 degrees, between 15 and 30 degrees, between 5 and 85 degrees, between 5 and 75 degrees, between 5 and 60 degrees, between 5 and 45 degrees, between 5 and 30 degrees, between 30 and 85 degrees, between 30 and 75 degrees, between 30 and 60 degrees, between 30 and 45 degrees, between 45 and 85 degrees, between 45 and 75 degrees, between 45 and 60 degrees, or any suitable combination, sub-combination, range, or sub-range therein).

Referring again to FIG. 1, in one embodiment, the support system 103 includes the gantry 105 extending from a location providing support for the load 117 being moved above or on the structure 107. Suitable positions include being on the structure 107, on the partially-assembled bridge 109, on a screed rail 123 with or without an engagement mechanism 137 having V-groove wheels and/or locks, on the screed rail 123 with multiple contact points distributing the mass to avoid damage to the screed rail 123 (for example, greater than 0.5 meters or otherwise, as shown in FIG. 3), on the bridge deck 127, on a pier 131, on a girder 133, on a deck pan 135, on an overhang, on rebar, on a ballast wall, on a wingwall, on a bearing seat, on an abutment wall, on a parapet, on a sidewalk, on an edge, on a beam, on pavement, on concrete, on a shear connector, of a combination thereof. Additionally or alternatively, in one embodiment, suitable positions include being on or in the physical feature 111, the physical feature 111 having a solid and/or liquid substance with a gas (air) space between the solid and/or liquid substance. In an alternative embodiment, the physical feature 111 has a solid substance below, without the gas (air) space.

According to an embodiment of the process 100 of assembling a bridge (not shown) from the partially-assembled bridge 109, the load location mechanism 115 is arranged and disposed to move the load 117 from being laterally-proximal to a first location 119 of the structure 107 and laterally-distal to a second location 121 of the structure 107 to being laterally-distal from the first location 119 of the structure 107 and laterally-proximal to the second location 121 of the structure 107.

According to one embodiment, the rate of movement from the first location 119 toward the second location 121 is based upon the grade and the mass of the load 117. Suitable rates include 0.3 meters per second (for example, at up to an 8% grade and a mass of about 7,711 kg) or 0.35 meters per second (for example, at up to a 6.5% grade and a mass of about 7,711 kg). Other suitable rates include, but are not limited to, 0.1 meters per second to 0.5 meters per second, 0.2 meters per second to 0.4 meters per second, 0.3 meters per second to 0.4 meters per second, or any suitable combination, sub-combination, range, or sub-range therein.

The capabilities of the load descent mechanism 113 and/or the load location mechanism 115 are achieved through features within the load positioning system 101 and/or within the load descent mechanism 113 and/or the load location mechanism 115. For example, in one embodiment, the load positioning system 101 includes one or more hooks, chains, shackles, wires, rails, ropes, cables, straps, pulleys, cranes, winches, gyroscopes, stabilizers, magnets, hydraulics, mechanical hoists, clamps, rings, skis, wheels (with or without locking clamps), handles, rain covers, trolleys, dollies, or combinations thereof to achieve the capabilities of the load descent mechanism 113 and/or the load location mechanism 115. In other embodiments, the load positioning system 101 includes augmented reality systems, vision measurement, vibration response, wind-response, partially autonomous systems, fully autonomous systems, or combinations thereof to achieve the capabilities of the load descent mechanism 113 and/or the load location mechanism 115.

In one embodiment, the load 117 is positioned to abut the gantry 105 while the load 117 is moving to provide stability. Such abutting position is able to be direct, with no separate materials between the gantry 105 and the load 117 or with materials or features (not shown) positioned between the load 117 and the gantry 105 (for example, lubricants, pads, foams, sacrificial layers, paint differing from other portions of the load positioning system 101, alignment guides/channels, or combinations thereof).

In an embodiment with the load 117 suspended from the gantry 105, for example, between 1 and 2 meters, an operator (not shown) is able to be positioned a safe distance from the load 117. For example, the load descent mechanism 113 is able to be controlled from a safe distance by the operator through a tether cable and/or wireless technology.

Referring to FIG. 7, in one embodiment, the gantry 105 has a frame 701 with various operational systems 703 already positioned on the frame 701. The gantry 105 has various portions allowing for the load positioning system 101 to be supported by the gantry 105 above the gantry 105, below the gantry 105, along a side of the gantry 105, within the gantry 105, or a combination thereof, whether a single embodiment of the load positioning system 101, multiple embodiments of the load positioning systems 101, or only portions of an embodiment of the load positioning system 101. The gantry 105 is able to be positioned perpendicular to gravity (“level”) or at an orientation other than perpendicular to gravity (inclined).

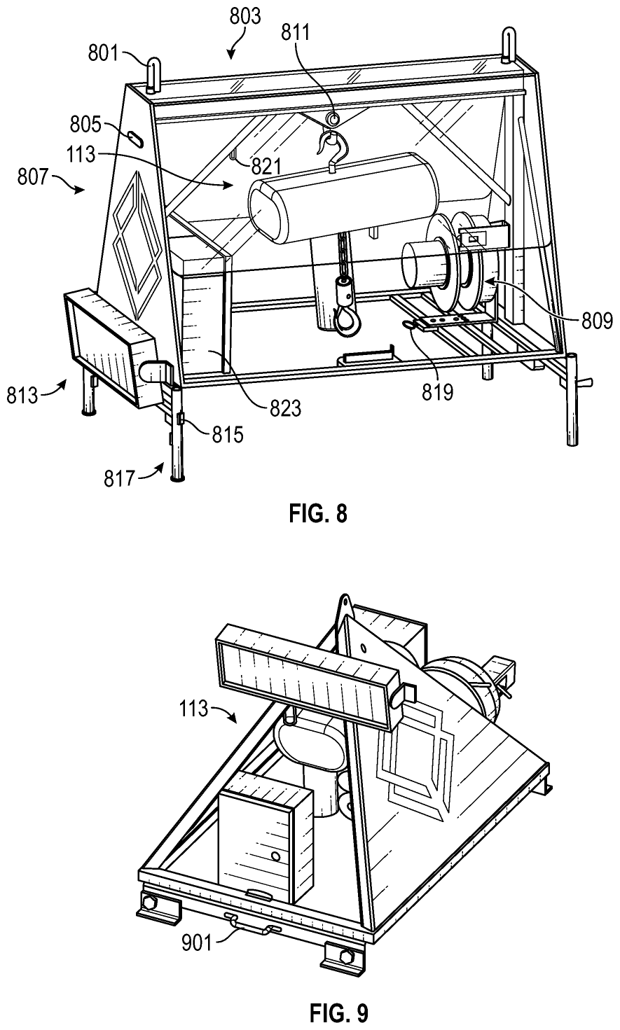

Referring to FIG. 8, in one embodiment, the load positioning system 101 has an A-frame configuration, for example, with twin panels enclosing features of the load positioning system 101. In the embodiment, the load positioning system 101 includes a lifting ring 801, a rain cover 803, running lights 805, a marketing panel 807, a cord reel 809, a load shackle 811, a load display 813, a toggle clamp 815, raised feet 817, a hook storage carabiner 819, a pendant storage carabiner 821, and a storage box 823. The lifting ring 801 connects the load descent mechanism 113 to the gantry 105. The rain cover 803 extends over electrical and/or mechanical features, allowing resistance to rain or other harsh conditions). The running lights 805 are able to correspond with regulatory requirements applicable to tall structures, bridges, utilities, or other uses, for example, by being red, green, yellow, white, or any other suitable color. The marketing panel 807 is able to display marketing information, safety information, instructions, or any other information desired by the user. The cord reel 809, the load shackle 811, the load display 813, the toggle clamp 815, the hook storage carabiner 819, and the pendant storage carabiner 821 allow operational features to raise and lower the load 118 in a safe and controlled manner. The raised feet allow 817 allow alignment adjustment, balancing, heightened positioning for when the load 117 is tall, or other suitable modifications from a set position. The storage box 823 is able to provide nearby access to tools or other items useful during the operation of the load positioning system 101 and/or the bridge assembly process 100.

Referring to FIG. 9, in one embodiment, the load positioning system 101 has a pyramid-like structure. In addition to optionally including any of the suitable features described in reference to other embodiments, the load positioning system 101 includes a grab handle 901, allowing adjustment and reposition from an individual repositioning system (not shown).

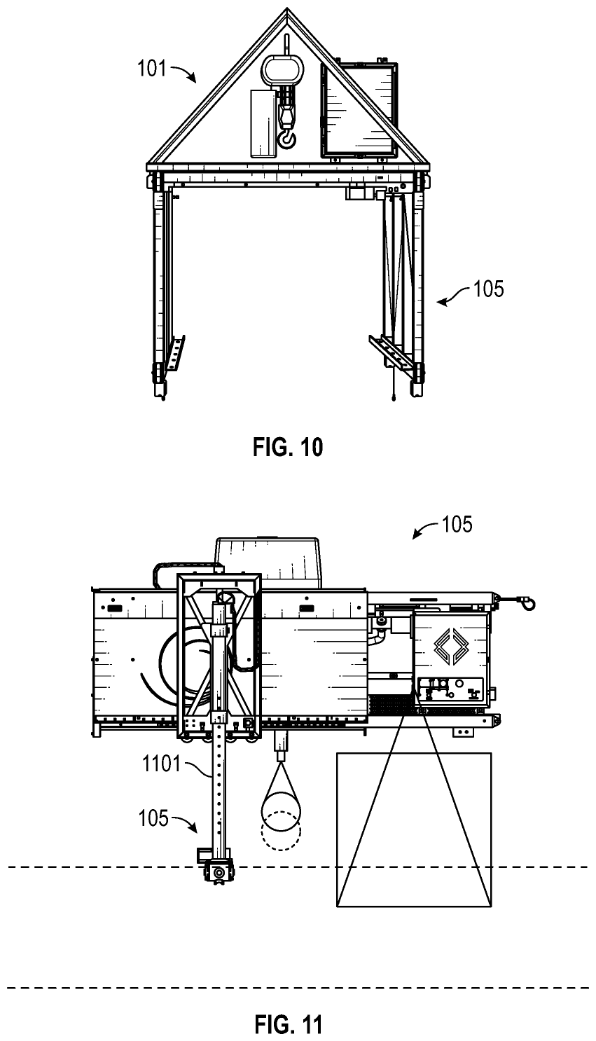

Referring to FIG. 10, in one embodiment, the load positioning system 101 is supported above the gantry 105. In addition to optionally including any of the suitable features described in reference to other embodiments, the position is capable of being fixed (for example, welded), slidably connected, or adjustable based upon fasteners or other removable securing mechanisms.

Referring to FIG. 11, in one embodiment, the load positioning system 101 has a spreader bar 1101 for levelling the load 117. In addition to optionally including any of the suitable features described in reference to other embodiments, the embodiment is able to allow adjustments that address distance between the gantry 105 and the physical feature 111, distance between the gantry 105 and a portion of the partially-assembled bridge 109, distance between the load 117 and the partially-assembled bridge 109, and/or distance between the load 117 and the physical feature 111.

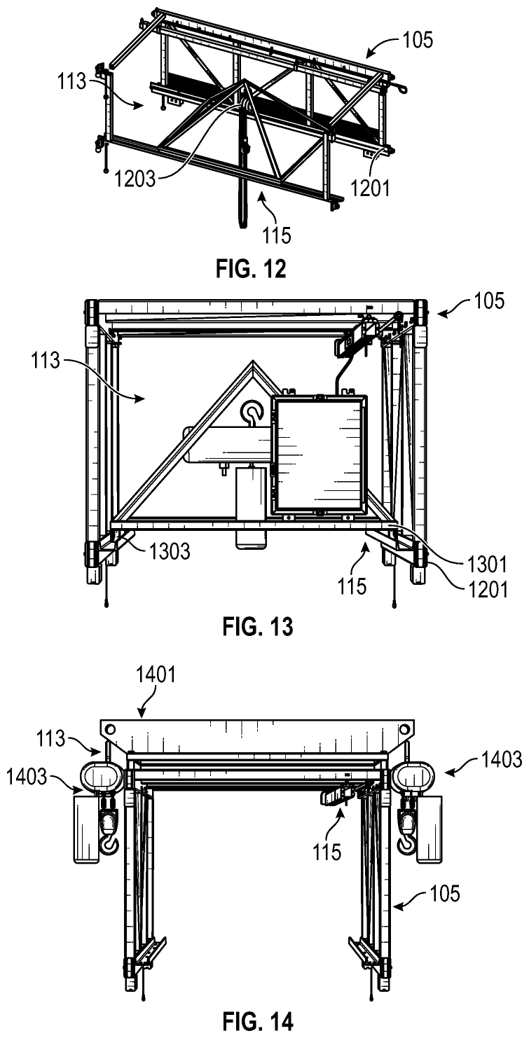

Referring to FIG. 12, in one embodiment, the load positioning system 101 slides on skis 1201 for location positioning and uses a mechanical hoist 1203 for load descent. In addition to optionally including any of the suitable features described in reference to other embodiments, the embodiment, the load positioning system 101 allows the skis 1201 to be positioned on the lower portion of the gantry 105 as shown or on an upper position. The skis 1201 are of a material for slidable movement with or without lubricant. In further embodiments, bearings, wheels, chains, or other mechanism to facilitate lateral movement are included. The mechanical hoist 1203 is positioned at the top of the load positioning system 101 with clearance on each side allowing adjustment of the load 117, for example, as described above with reference to FIG. 6.

Referring to FIG. 13, in one embodiment, the load positioning system 101 moves on the skis 1201 with wheels 1301 and clamps 1303 able to secure the load 117 in a specific position. In addition to optionally including any of the suitable features described in reference to other embodiments, the load positioning system 101 allows the clamps 1303 to prevent movement of the load 117, for example, in response to forces such as wind or gravity.

Referring to FIG. 14, in one embodiment, the load positioning system 101 includes a sled 1401 positioned on top of the gantry 105, with twin hoists 1403, allowing balancing of the load 117. In addition to optionally including any of the suitable features described in reference to other embodiments, the load positioning system 101 allows the twin hoists 1403 to orient the load 117 with one side being higher than the other. In further embodiments with more than two of the twin hoists 1403, additional movement and orientation of the load 117 is enabled.

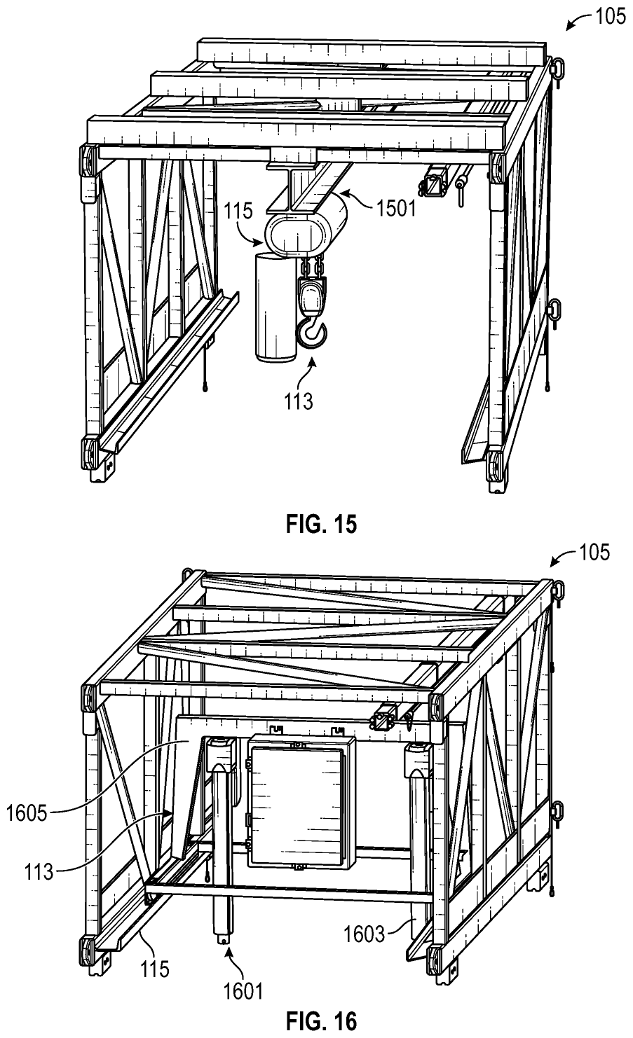

Referring to FIG. 15, in one embodiment, the load positioning system 101 includes a beam 1501 with the trolley 401 (see FIG. 4) connected to the beam 1501, thereby allowing movement of the load 117. In addition to optionally including any of the suitable features described in reference to other embodiments, the load positioning system 101 allows the beam 1501 to support the load descent mechanism 113 in an adjustable manner.

Referring to FIG. 16, in one embodiment, the load positioning system 101 includes a first actuator 1601 and a second actuator 1603, each mounted to a lifting bar 1605, In addition to optionally including any of the suitable features described in reference to other embodiments, the embodiment allows balancing of the load 117, integrated force measurement, avoidance of use of a chain hoist, and lower mass than a power hoist.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A load positioning system, comprising:
a gantry extending over a structure of a partially-assembled bridge, the partially-assembled bridge at least partially extending over a physical feature;
a load descent mechanism arranged and disposed to lower a load having a mass of at least 10 kg onto the structure; and
a load location mechanism arranged and disposed to move the load from being laterally-proximal to a first location of the structure and laterally-distal to a second location of the structure to being laterally-distal from the first location of the structure and laterally-proximal to the second location of the structure;
wherein the load descent mechanism and the load location mechanism are physically supported by the gantry.

2. The load positioning system of claim 1, wherein the load descent mechanism is further arranged and disposed to raise the load.

3. The load positioning system of claim 1, further comprising an additional load descent mechanism supported by the gantry.

4. The load positioning system of claim 1, where the load positioning system is supporting the load, and the load is or includes components for the partially-assembled bridge.

5. The load positioning system of claim 1, where the load positioning system is supporting the load, and the load is or includes tools for the process of constructing the bridge.

6. The load positioning system of claim 1, where the load positioning system is supporting the load, and the load is or includes systems for analyzing the partially-assembled bridge.

7. The load positioning system of claim 1, wherein the gantry is on the structure.

8. The load positioning system of claim 1, wherein the gantry is on or within the physical feature.

9. The load positioning system of claim 1, wherein the gantry extends over the structure and at least a portion of the physical feature, the physical feature being a body of water with air above the body of water.

10. The load positioning system of claim 1, wherein the gantry extends over the structure and at least a portion of the physical feature, the physical feature being land with air above the land.

11. The load positioning system of claim 1, wherein the gantry extends over the structure and at least a portion of the physical feature, the physical feature being a paved surface with air above the paved surface.

12. The load positioning system of claim 1, wherein at least a portion of the load positioning system is secured to the gantry by chains, cables, wires, ropes, or combinations thereof.

13. The load positioning system of claim 1, wherein at least a portion of the load positioning system is secured to the gantry by hydraulic mechanisms.

14. The load positioning system of claim 1, wherein the structure is a bridge deck.

15. The load positioning system of claim 1, wherein the mass of the load is at least 100 kg.

16. The load positioning system of claim 1, wherein the mass of the load is at least 1,000 kg.

17. The load positioning system of claim 1, wherein the load positioning system includes twin hoists balancing the load, one or more gyroscopes balancing the load, or a combination thereof.

18. The load positioning system of claim 1, wherein the load positioning system includes a beam secured to the gantry and a trolley connected to the beam, the trolley being a portion of the load location mechanism allowing movement of the load.

19. A partially-assembled bridge, comprising:
a structure at least partially extending over a physical feature, the structure including components for assembling a bridge;
a load, the load having a mass of at least 10 kg;
a load positioning system having a load descent mechanism and a load location mechanism, the load descent mechanism being arranged and disposed to lower the load onto at least a portion of the structure and the load location mechanism being arranged and disposed to move the load from being laterally-proximal to a first location of the structure and laterally-distal to a second location of the structure to being laterally-distal from the first location of the structure and laterally-proximal to the second location of the structure; and
a gantry;
wherein the load descent mechanism and the load location mechanism are physically supported by the gantry.

20. A process of assembling a bridge, comprising:
providing a structure at least partially extending over a physical feature, the structure including components for assembling a bridge;
providing a load positioning system having a load descent mechanism and a load location mechanism;
using the load descent mechanism to lower a load having a mass of at least 10 kg onto at least a portion of the structure;
using the load location mechanism to move the load from being laterally-proximal to a first location of the structure and laterally-distal to a second location of the structure to being laterally-distal from the first location of the structure and laterally-proximal to the second location of the structure;
wherein the load descent mechanism and the load location mechanism are physically supported by a gantry.
